(19) United States
(12) Patent Application Publication
(10) Pub. No.: US 2005/0080504 A1
(43) Pub. Date: Apr. 14, 2005

(54) Design change assistance system

(75) Inventors: Ichiro Kataoka, Chiyoda (JP); Takashi Yokohari, Iwai (JP); Hiroyuki Nemoto, Tokyo (JP); Ichiro Nishigaki, Ishioka (JP)

Correspondence Address: McDermott, Will & Emery, 600, 13th Street, N.W., Washington, DC, 20005-3096, US

(73) Assignee: HITACHI., LTD.

(21) Appl. No.: 10/768,171

(22) Filed: Feb. 2, 2004

(30) Foreign Application Priority Data
Oct. 9, 2003 (JP) 2003-351131

(51) Int. Cl. G06F 19/00

(52) U.S. Cl. 700/105; 700/97

(57) ABSTRACT

In a design change assistance system for assisting for an evaluation on related influential factors in a design change when conducting the design change, a case input means for inputting a design change case, including existing design change contents and an item of an influential factor relating to the design change contents. The data inputted through the case input means is accumulated in a database. Contents of the design change on an evaluation target are inputted through an evaluation target design change input means. An evaluation on the influential factor about the design change on the evaluation target, which is inputted in the evaluation target design change input means, is delivered by a design change evaluation delivery means, upon basis of the case data accumulated in said database.

### BACKGROUND OF THE INVENTION

The present invention relates to an assistance system of design change, for assisting an evaluation on an influential factor(s) relating thereto in the change of design, when changing the design made upon the basis of the existing design.

A cost estimation system of using a computer therein was already introduced, and then, as is described in Japanese Patent Laying-Open No. 2002-202996 (2002) or in Japanese Patent Laying-Open No. Hei 7-282142 (1995), even a designer who is not familiar with the processing method, etc., can easily make an approximate estimation on cost of a target of design. For example, in a parts cost estimation system disclosed in the Japanese Patent Laying-Open No. 2002-202996 (2002) mentioned above, it is possible to make estimation upon processing costs, as well as, to calculate out the cost of parts, by setting a processing pattern and the processing method thereof.

Also, a large number of proposals for a system are made, which can visualize the various conditions of the processes, such as, in Japanese Patent Laying-Open No. 2002-182719 (2002) or Japanese Patent Laying-Open No. 2001-125962 (2001), etc. For example, in the Japanese Patent Laying-Open No. 2002-182719(2002), there is proposed an information disclosure system, wherein information, such as, about delivery time limit and/or costs relating to a supplier of parts, which are necessary for the manufacturing process, is visualized under the condition of being related to the processes, to be provided to a user. Also, in the Japanese Patent Laying-Open No. 2001-125962 (2001), there is proposed a system, wherein financial data for a predetermined number of past years, as well as, external environment data of an undertaking are inputted, and then financial items and initial values thereof are displayed, which are necessary and sufficient for making a management simulation, thereby accompanying the processes of, such as, prompting the user to confirm or to make an input thereto.
Patent Document 1: Japanese Patent Laying-Open No. 2002-202996 (2002);
Patent Document 2: Japanese Patent Laying-Open No. Hei 7-282142 (1995);
Patent Document 3: Japanese Patent Laying-Open No. 2002-182719 (2002); and
Patent Document 4: Japanese Patent Laying-Open No. 2001-125962 (2001).

When designing a product of a mechanical structure or parts thereof, etc., there may be a case of designing it newly, as well as, a case of chaining the design by adding partial alternation upon the basis of the existing design, and there are many cases of changing the existing design. When making such the change on the existing design, it is a necessity to make studies on various influential factors, for the purpose of evaluation thereof. The followings are the influential factors, on which the evaluation is necessary to be made; a cost generated accompanying with the change of design; changes in performances relating to the change of design; and contents of the change of design which are made on related function part(s), on which a necessity of changing the design is caused accompanying with the change of design on an objective portion, in relation thereto. A designer makes studies and evaluation on the cost items, such as, which kind of costs is generated, and to what extent or degree the cost reaches accompanying with the contents of the design change which is aimed at, when making changes upon the existing design. He/she also makes the studies and the evaluation, on how the performances are changed if making such the change of design in the direction that is aimed at. Further, there is also a necessity of making the studies and the evaluations thereon; in particular, if there occurs a related function part(s) or not, on which the design change must be made in addition thereto, from a viewpoint of the functional relation therewith, or what are the contents of the related changes of design, accompanying with the design change made on the portion aimed at. Regarding the change of design, it is also necessary to make the studies and the evaluation on an achievement, in particular, of an amount of the cost reduction and a ratio of improvement on the performances, on each of which is set an object.

In this manner, when making the change of design, for the designer, it is required to acknowledge the large numbers of related influential factors, as well as, to evaluate them with accuracy. The more the number of the parts building up the object, on which the design change is made, the more complicate the relationships between the influential factors, thereby enlarging a load or burden of making the evaluation thereon. As a result thereof, there occurs an afraid or possibility of bringing about a situation of causing an error when calculating out the costs and/or the performances.

A system is desired, for giving an appropriate assistance on the evaluation of the influential factors mentioned above, in particular, when making such the change of design. However, such the conventional assistance systems relating to the design workings, as is known by the Patent Documents 1 and/or 2, representatively, has no function of assisting the evaluation mentioned above, and therefore it is insufficient to be a means for design assistance. Also, upon assisting the evaluation on the influential factors when making the change of design, it is desired to visualize and display the complicated relationships between the influential factors with respect to the change of design, thereby promoting the designer to be practiced or familiar with the relationship between the change of design and the related influential factors. In the Patent Documents 3 and 4, there are disclosed technologies for visualizing the processes, however, no consideration is taken into, in particular, about visualization of the influential factors in the change of design.

### BRIEF SUMMARY OF THE INVENTION

According the present invention, being achieved in consideration of the drawbacks relating to the conventional technologies mentioned above, an object thereof is to achieve or provide a design change assistance system for assisting an evaluation of the influential factors, being necessary when changing the existing design. Other object, according to the present invention, is provide the design change assistance system, being able to visualize the relationships between the influential factors, in respect to the contents of the change of design.

For accomplishing the object mentioned above, according to the present invention, first there is provided a design change assistance system for assisting an evaluation on a related influential factor in a design change, when conducting the design change, comprising: a case input means for inputting a design change case, including existing design change contents and an item of an influential factor relating to the design change contents; a database for accumulating data inputted through said case input means; an evaluation target design change input means for inputting contents of the design change on an evaluation target; and a design change evaluation delivery means for delivering an evaluation on the influential factor about the design change on said evaluation target inputted in said evaluation target design change input means, upon basis of the case data accumulated in said database.

Also, according to the present invention, in the design change assistance system as described in the above, said influential factor includes at least one or more of: a cost item accompanying with the design change on said evaluation target, a performance change of a design change target product accompanying with the design change on said evaluation target, and a presence of a related function part, on which a related design change is necessary accompanying with the design change on said evaluation target.

Also, according to the present invention, in the design change assistance system as described in the above, such design change contents can be delivered from upon basis of said case data, that a target cost and/or a target performance, which is set up for an object of the design change, can be achieved.

Further, according to the present invention, there is also provided a design change assistance system for assisting an evaluation on a related influential factor in a design change, when conducting the design change, comprising: a case input means for inputting a design change case, including existing design change contents and an item of an influential factor relating to the design change contents; a database for accumulating data inputted through said case input means; and an evaluation target design change input means for inputting contents of the design change on an evaluation target, wherein: a relationship of said influential factor with respect to said evaluation target design change inputted in said evaluation target design change input means can be displayed in a form of a design change influence network, by means of a combination of a node display and a linkage display, upon basis of the case data accumulated in said database.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an embodiment; i.e., a design change assistance system, according to the present invention;

FIG. 2 is a table for showing an example of basic materials for cost calculation;

FIGS. 3 to 8 are views for showing examples of various screens, in particular: FIG. 3 is a view for showing an initial screen; FIG. 4 is a view for showing a basic system screen; FIG. 5 is a view for showing a design change contents node registration screen; FIG. 6 is a view for showing a linkage registration screen for use of costs; FIG. 7 is a view for showing a linkage registration screen for use of a related function part; and FIG. 8 is a view for showing a linkage registration screen for use of performances, respectively;

FIGS. 9 to 11 are views for showing examples of various tables, which are used in the present system, in particular: FIG. 9 shows a cost rule table; FIG. 10 a relational function portion rule table; and FIG. 11 a performance change rule table, respectively;

FIG. 12 is a flowchart for cost evaluation in the change of design;

FIGS. 13 and 14 are views for showing examples of screens, in particular: FIG. 13 shows a change contents inputting screen; and FIG. 14 a display screen of a design change influence network, respectively;

FIG. 15 is a flowchart for performance change evaluation in the change of design;

FIG. 16 is a view for showing a display screen of the design change influence network for showing a result of the above;

FIG. 17 is a flowchart for making evaluation on the related function part in the change of design;

FIG. 18 is a flowchart of study and evaluation for use in achieving a target cost;

FIGS. 19 and 20 are views for showing examples of screen, in particular: FIG. 19 shows a target cost inputting screen; and FIG. 20 a display screen of the design change influence network for achieving the target cost, respectively;

FIG. 21 is a flowchart of study and evaluation on the change of design for achieving target performances;

FIG. 22 is a flowchart for display of the design change influence network; and

FIG. 22 is a view for showing an example of the display screen for displaying the design change influence network.

### DETAILED DESCRIPTION OF THE INVENTION

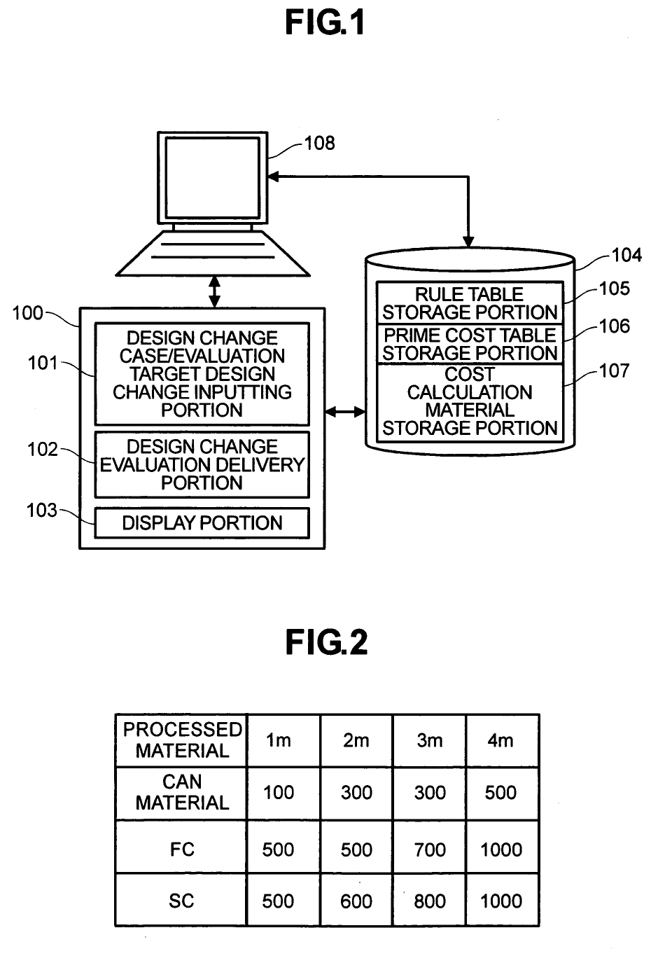

Hereinafter, embodiments according to the present invention will be fully explained, by referring to the attached drawings. First, FIG. 1 shows the configuration of a design change assistance system, according to an embodiment of the present invention. The design change assistance system comprises a data processing apparatus 100. This data processing apparatus 100 comprises a design change case/evaluation target design change inputting portion 101, a design change evaluation delivering or outputting portion 102, and a display portion 103, each being built up to be a processing means with an aid of the computer program, respectively. Also, the design change assistance system comprises a database 104. This database 104 includes a rule table storage portion 105, being a case data storage portion for storing therein the data in relation to cases, which will be mentioned later, and further includes a prime cost table storage portion 106 and a cost calculation material storage portion 107. Further, the design change assistance system comprises a display apparatus 108 for displaying the screens thereon, being necessary in various processes which will be mentioned later.

The design change case/evaluation target design change inputting portion 101 prepares various inputting screens therein, which will be mentioned later, thereby to be used for inputting the existing cases of design changes, to be accumulated in the rule table storage portion 105 within the database 104, and also for inputting the contents of the design changes as of an evaluation target. In inputting of the design change case, the contents of the design change is inputted (i.e., the content of the change of design is “change a size of a rear panel from A to B”, if a target of the design change is a refrigerator, for example, and in particular, in a case when the change is made on a size of a rear panel), and are also inputted, in addition thereto; such as, items relating to the costs (for example, the prime cost factors, such as, a material cost, a processing const, a general cost, etc., as well as, a cost for each of those prime costs, etc.), the changes in performances, and the related function parts, on which the change of design must be made, additionally, and the contents of that change of design (also accompanying the cost items and the change of performances, in the contents of the change of design on this related function part), and so on. And, according to the present embodiment, the data of cases inputted are stored into the rule table storage portion 105 in the form of the various rule tables, wherein a “rule” is defined as a relationship between an each influential factor and the content of the change of esign, which will be mentioned later. On the other hand, in inputting of the evaluation target design change, the contents of the design change are inputted, on which is aimed at the evaluation.

The design change evaluation delivery portion 102 delivers or outputs an evaluation of the influential factors, in relation to the design change of the evaluation target, the contents of which are inputted in the design change case/evaluation target design change inputting portion 101. The delivery of that evaluation of the influential factors is conducted by using that case, in a case if there is a case corresponding to (i.e., the case being same or similar to) the design change on the evaluation target, or only the cost items by using the prime cost table storage portion 106 and/or the data accumulated in the cost calculation material storage portion 107, in a case if there is no case corresponding thereto. The display portion 103 produces the design change influence network, to be displayed. The design change influence network is provided for the purpose of visualizing the relationships between the influential factors with respect to the contents of design change, to be displayed, with an aid of combination of a node display (i.e., a display of each of the items within the contents of design change, and/or of each of the items of the influential factors) and a linkage display (i.e., a display of relationships thereof), in a manner of a network, and it is used in the display or the like, of an evaluation result delivered, in the design change evaluation delivery portion 102.

In the rule table storage portion 105 within the database 104, as was mentioned above, there are stored the various kinds of rule tables, in which those relationships are defined as the “rules” between the contents of design change and the respective influential factors. Also, there are further stored the primary cost tables in the prime cost table storage portion 106. And in the cost calculation material storage portion 107, there are stored basic materials to be used in the calculation of costs. An example of the basic materials for use in the cost calculation is shown in FIG. 2. This example is one for showing a relationship between the size and the cost of a material in the form of a table, wherein a cost is shown depending upon length of the material for each one of the kinds of materials (i.e., a can material, FC, SC).

Then, explanation will be given on an outlook of the processing, which is conducted in the design change assistance system, the structure of which was shown in the above. The processing that is conducted in the design change assistance system includes the following four (4) kinds: (1) registration of the cases relating to the design change that was made already; (2) an evaluation of the influential factors relating to the design change, which will be made, newly; (3) studying/evaluating the design change, being appropriate for achieving a target of cost reduction, which is set up for a design target; and (4) studying/evaluating the design change, being appropriate for achieving a target of improvement on performances, which is set up for a design target.

In registration of the cases, as was mentioned above, with using the design change case/evaluation target design change inputting portion 101, the influential factors are inputted, relating to the contents of the existing design change and also the contents of that design change (i.e., the cost items, the changes of performances, the related function parts, etc.). This input is conducted by defining a relationship between the influential factors, with respect to the contents of design changes, as the “rule”. And, the cases inputted are stored into the rule table storage portion 105, in the form of the various rule tables, in which the relationships are defined as the “rules”, as was mentioned above, between the influential factors, with respect to the contents of design changes.

In case when conducting an evaluation on the design change, which will be made, newly, first of all, a user (i.e., an operator of the present system) inputs the contents of the design changes to be made on the evaluation target into the present system. Then, the present system makes a search on a case, corresponding to the design change contents inputted, from the rule table storage portion 105, upon the basis of an appropriate keyword(s). In a case if there is found a case corresponding thereto, the evaluation on the influential factors can be delivered upon the basis of that corresponding case, and a result thereof, it is displayed on the display 108, in the form of the design change influence network or the like, or in the place thereof, the design change influence network is displayed thereon, which is produced upon the basis of the corresponding case. Then, the user is able to proceed or advance the evaluation upon the design change on the evaluation target (i.e., the cost items, the changes of performances, the related function parts, etc.), while confirming the influential factors relating thereto on this display.

In the study/evaluation of the design change for achieving the cost reduction that is aimed at, first of all, the user inputs into the present system, a kind of the cost (i.e., the prime cost factor) to be reduced, as well as, the present cost and the target cost thereof. Then, the present system makes a search on a rule table within the rule table storage portion 105, with using the kind of the cost inputted as the keyword thereof, thereby searching out the case corresponding thereto. In a case if there is found a case corresponding thereto, it is displayed on the display apparatus 108, therefore the user can make study in an appropriate direction for the design change, by referring thereto.

In the study/evaluation of the design change for achieving the improvement on performances that is aimed at, first of all, the user inputs into the present system, a kind of the performance, on which the improvement should be made, as well as, the present performance and the target performance thereof. Then, the present system makes a search on a rule table within the rule table storage portion 105, with using the kind of the performance inputted as the keyword thereof, thereby searching out the case corresponding thereto. In a case if there is found a case corresponding thereto, it is displayed on the display apparatus 108, therefore the user can make study in an appropriate direction for the design change, by referring thereto.

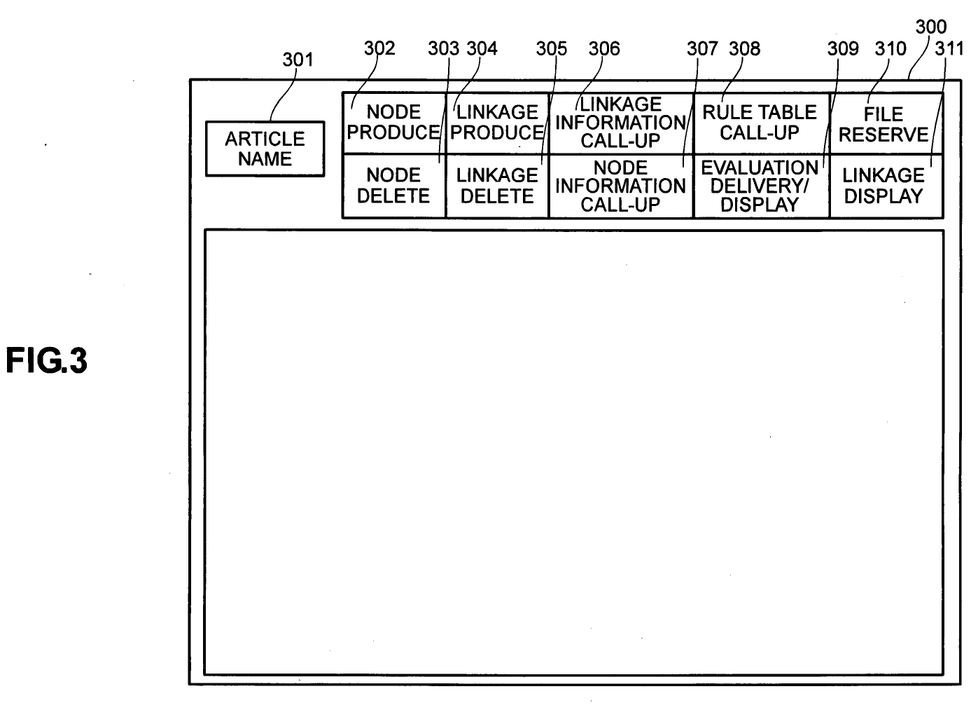

Hereinafter, explanation will be made on the details, in particular, of each of the processes, which are mentioned briefly in the above. First of all, explanation will be given on the registration process. When starting the present system, an initial screen 300 is displayed, as is shown in FIG. 3. In the initial screen 300, there are prepared the followings: an article name display portion 301 for displaying an article name of a target of designing (i.e., a design target); a node produce button 302 to be used when producing a node; a node delete button 303 for deleting a node when the node is produced erroneously; a linkage produce button 304 to be used when producing (or setting up) a linkage; a linkage delete button 305 for deleting a linkage when the linkage is produced erroneously; a linkage information call-up button 306 for calling up a linkage information; a node information call-up button 307 for calling up a node information; a rule table call-up button 308 for calling up a rule table; an evaluation delivery/display button 309 to be used for bringing about the delivery of evaluation, in relation to the influential factors and the display thereof; a file reserve button 310 of indicative of reservation of a result of processing; and a linkage display button 311 for bringing the design change influence network to be displayed.

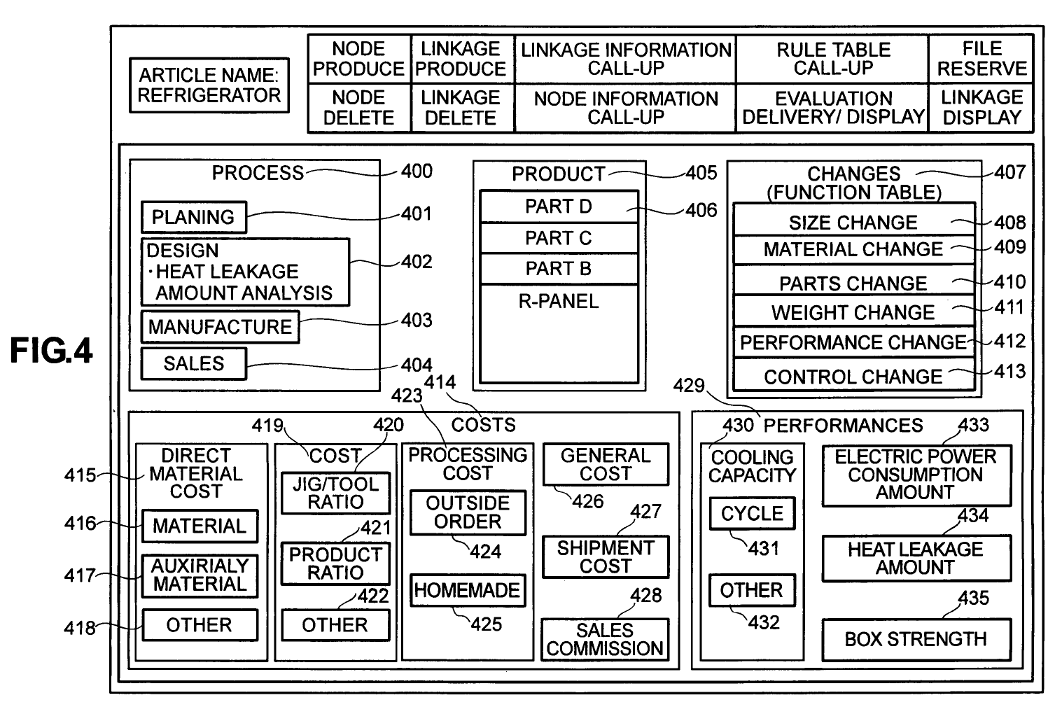

A basic system screen, such as shown in FIG. 4, is displayed, when inputting, for example, a “refrigerator”, as to be an article name of the design target, in the article name display portion 301 on the initial screen 300. This screen is made up with the initial screen 300, with putting a process region 400, a product region 405, a change region (a function table region) 407, a cost region 414, and a performance region 429, etc., in addition thereto, for use of displaying the design change influential network.

The process region 400 is a region where the node is displayed relating to each of the processes, starting from planning up to sales about an article of the design target. In an example of the figure, there are prepared a planning note 401, a design node 402, a manufacture node 403, and a sales node 404.

The product region 405 is a region for indicating the parts structure of the article, etc., for the design target, and within the region thereof is prepared a parts region 406. And, in this parts region 406 are prepared nodes in relation to each part of the article of design target. In an example shown in the figure, since the article of design target is the refrigerator, an R-panel (rear panel) is displayed therein, as well as, the parts B-D other than that.

The change region 407 is a region for indicating the node relating to a kind of the design change therein. In the example of the figure, there are prepared a size change node 408, a material change node 409, a parts change node 410, a weight change node 411, a performance change node 412, and a control change node 413.

The cost region 414 is a region for indicating the prime const factors building up the manufacturing const of the design target. In this cost region 414, there are provided sub-regions for each of the prime cost factors. In the example shown in the figure, there are prepared a direct material cost region 415, a cost region 419, a processing cost region 423, and a general cost region 426. And, in the direct material cost region 415, there are prepared a material node 416, an auxiliary material node 417 and other node 418; in the cost region 419, there are prepared a jig/tool ratio node 420, a product ratio node 421 and other node 422; in the process cost region 423, there are prepared an outside order node 424 and a homemade node 425; and in the general const region 426, there are prepared a shipping cost node 427 and a sales commission node 428.

The performance region 429 is a region for indicating nodes, in relation to the change of performances accompanying with the design change. In the example shown in the figure, there are prepared a cooling capacity node 430, an electric power consumption node 433, a heat-leakage amount node 434, and a box strength node 435, and further, below the cooling capacity node 430, there are prepared a cycle node 431 and other node 432.

Further, there also should be prepared a region relating to the related function part other than those regions, however in the present embodiment, the product region 405 for indicating the parts construction of the design target is used in common with, as the related function part region thereof.

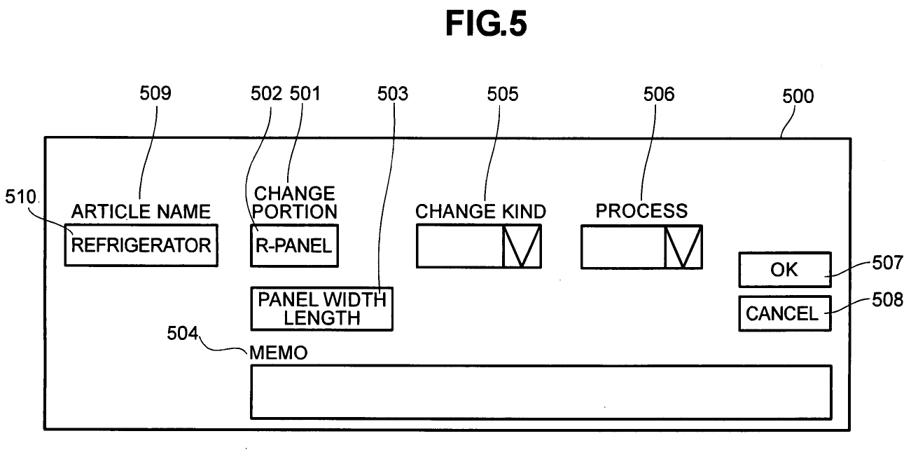

The registration process of the cases is carried out, as will be explained below, by using such the basic system screen. In registration of a case, first the design change contents are registered, for the existing design change to be registered as that case. For that purpose, the node produce button 302 is pushed down. Then, a design change contents node registration screen is called up for prompting to input data into the nodes relating to the design change contents. FIG. 5 shows an example of the design change contents node registration screen. This design change contents node registration screen 500 has a change portion column 501, a memo column 504, a change kind column 505, a process column 506, an OK button 507, a cancel button 508, and an article column 509.

The change portion column 501 is a column where an input is made on a portion (such as, the parts, etc.) of the target of design change, in a form of the node. In this change portion column 501, there are provided a plural numbers of columns. In the example shown in the figure, there are provided two (2) columns 502 and 503. The reason for providing the plural number of columns within the change portion column 501, in this manner, lies in that: assuming that the change target portion is a part, such as, being called by a R-panel, for example, there is also further necessity of a sub-classification of kind, being indicative of which part is a target of the design change in that R-panel. A column 502 of an upper classification of kind, in this example, is a column where the target part of the design change is inputted by the name of a class or kind, such as, the name of the parts, for example, and an input can be made by using the parts name prepared in the parts region 406 on the basic system screen shown in FIG. 4. In the case where the input is made by using the parts in the parts region 406, a click is made on the node of the corresponding parts within the parts region 406. In the example shown in the figure, the “R-panel” is inputted. On the other hand, the column 503 of the sub-classification of kind is a column where an input is made, being indicative of which portion is the target of the design change in the parts, which are inputted in the column 502. In the example shown in the figure, “panel width length” is inputted therein.

In the change kind column 505 is a column where an input is made on the node relating to the kind of the design change, and an input can be made, by selecting one from among the change kind nodes, which are prepared in the change region 407 on the basic system screen shown in FIG. 4. When making an input into the change kind column 505, if the change kind node to be inputted accompanies a quantitative change or a numerical value change, such as, in the case of the “size change”, for example, an amount or quantity of the change is also inputted. The process column 506 is a column where an input is made on the node relating to the process, which the design change relates to, and an input can be made by selecting one from among the process nodes, which are prepared in the process region 400 on the basic system screen shown in FIG. 4. The memo column 504 is a column where the user can describe a memo therein, freely, in relation to the design change. In the example in the figure, the column is in the condition that no input is made therein, yet.

In such the design change contents node registration screen 500, when the OK button 507 is pushed down after inputting the design change contents into the each corresponding column, in a form of the node, in the design change to be registered as that case, then those data are registered/reserved into the various rule tables within the rule table storage portion 105, which will be mentioned later, under the condition that a relationship is given between each of the design change contents.

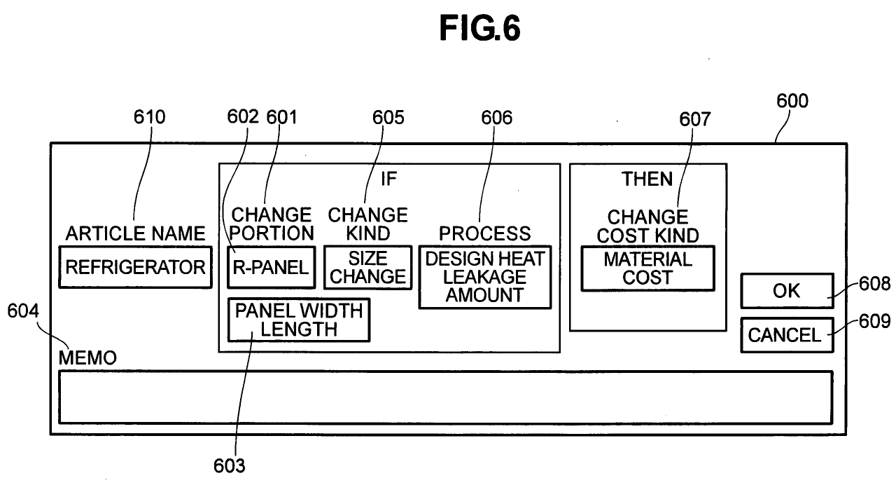

Next, registration is made on the influential factors corresponding to the design change contents registered; i.e., a linkage is established between the related influential factors with respect to the design change contents registered. For that purpose, first of all, the linkage produce button 304 is pushed down, and then a click is made on the region of linkage objects. Then, a linkage registration screen is called up for registering the influential factors while setting up a linkage with respect to the design change contents. Examples of the linkage registration screens are shown in FIGS. 6 to 8. A linkage registration screen 600 shown in FIG. 6 is for use of setting up a linkage with respect to the design change contents of the cost item, being one of the influential factors. This linkage registration screen 600 for use of the cost has a change portion column 601, a memo column 604, a change kind column 605, a process column 606, a change cost kind column 607, a OK button 608, a cancel button 609, and an article name column 610.

In the change cost kind column 607 is a column where an input is made on a kind of cost, to be changed accompanying with the design change (such as, the prime cost factor), and an input can be made by selecting one from among the cost nodes, which are prepared in the cost region 414. The structure of each of the columns other than this corresponds to the change portion column 501, the memo column 504, the change kind column 505, the process column 506, and the article name column 509 on the design change contents node registration screen 500, respectively. Therefore, the explanation made in the above will be quoted herein, about those.

In such the linkage registration screen 600 for use of the cost, in particular, in a case when conducting the process continuing after the registration of the design change contents mentioned in the above, it is possible to use the nodes relating to the contents of design change as they are, which are registered previously on the design change contents node registration screen 500. In the example shown in the figure, the “R-panel” and the “panel width length” are inputted into the columns 602 and 603 of the change portion column 601, respectively, the “size change” into the change kind column 605, and “design, heat-leakage amount analysis” in the process column 606. In set-up of the linkage relating to the cost, in particular, in the case where the design change contents nodes can be used in this manner, an input into the change cost kind column 607 is made on the linkage registration screen 600 for the costs. In the example shown in the figure, “material cost” is inputted as the kind of the change cost. When pushing down the OK button 608 under this condition, the data setting up the linkage between the design change contents and the cost items is registered/reserved into the rule table storage portion 105, in the form of a cost-rule table.

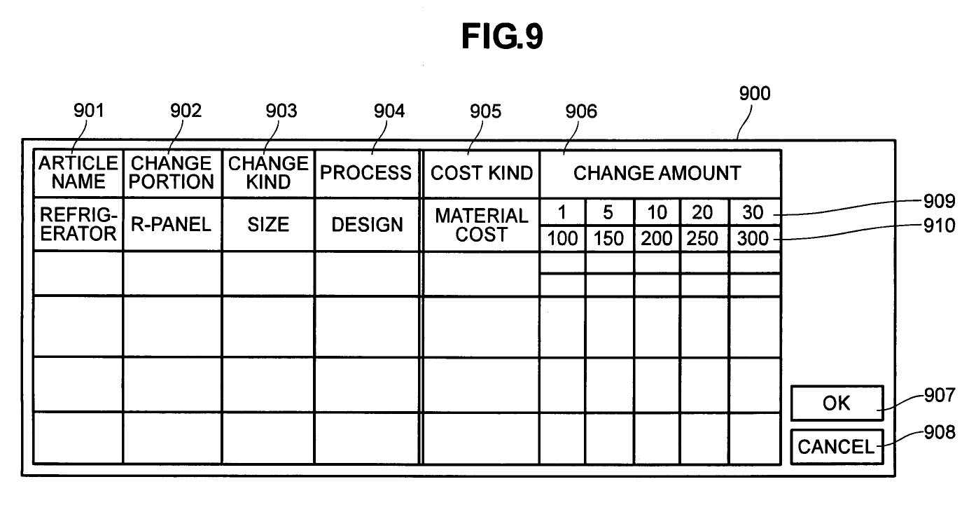

FIG. 9 shows an example of the cost-rule table. In this cost-rule table 900 are provided: an article name column 901, a change portion column 902, a change kind column 903, a process column 904, a cost kind column 905, a change amount column 906, an OK button 907, and a cancel button 908. Each of the article name column 901, the change portion column 902, the change kind column 903, the process column 904 and the cost kind column 905 corresponds to the each of the columns on the design change contents node registration screen 500 or the linkage registration screen 600 for the costs, and the nodes which are inputted on the design change contents node registration screen 500 or the linkage registration screen 600 for the cost are registered in each column of those. The change amount column 906 is a column where quantity of the change is registered therein, in particular, in the case where the contents of design change accompany the quantitative change or the numerical value change therewith. In the example shown in the figure, it is divided into an upper stage 909 and a lower stage 910, and the change quantity is registered in the upper stage 909 and the cost corresponding to the change quantity into the lower stage 910.

Herein, the cost-rule table 900 may be so structured, that data can be inputted into each of the columns thereof, and with doing so, it is possible to register the cases with using the cost-rule table 900. In the present embodiment, it is also possible to achieve the registration of the cases with using this cost-rule table 900. The registration of the cases by means of the cost-rule table 900 is conducted, through calling up the cost-rule table 900 by means of the rule call-up button 308.

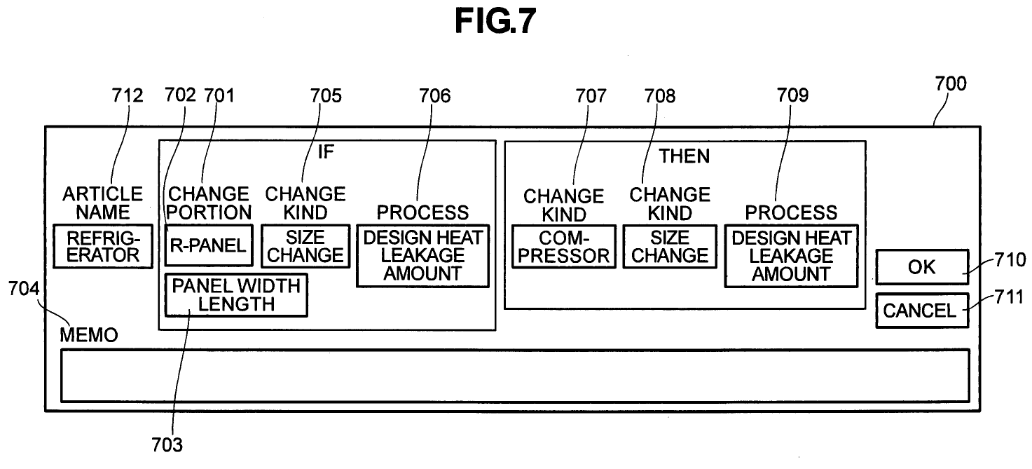

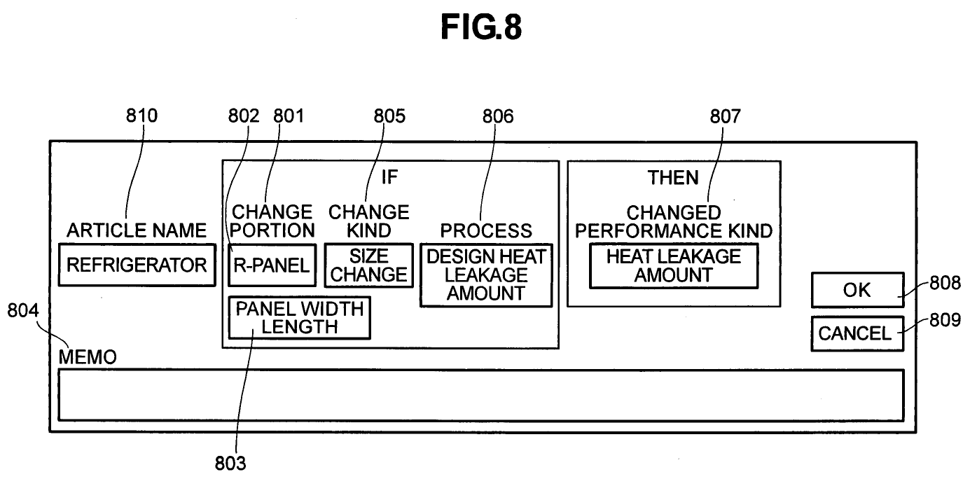

The linkage registration screen 700 shown in FIG. 7 is provided for use of set-up of a linkage, for the design change contents of the related function part, being one of the influential factors. This linkage registration screen 700 for use of the related function part comprises: a change portion column 701, a memo column 704, a change kind column 705, a process column 706, a change portion column 707 of the related function part, a change kind column 708 of the related function part, a process column 709 of the related function part, an OK button 710, a cancel button 711, and an article name column 712.

The related function part change portion column 707 is a column where an input is made on the design change portion (such as, the parts, etc.), to be a target in the related function part, on which the design change is made, additionally, in the form of the node, and an input can be made, by using the article name prepared in the product region 405 on the basic system screen shown in FIG. 4. The related function part change kind column 708 is a column, where an input is made on the node in relation to a kind of design change on the related function part, and an input can be made, by selecting one from among the change kind nodes prepared in the change region 407. The related function part process column 709 is a column, where an input is made on the node in relation to the manufacturing process relating to the design change made on the related function part, and an input can be made by selecting one from among the process nodes prepared in the process region 400. The structure of each of the columns other than those corresponds to the change portion column 501, the memo column 504, the change kind column 505, the process column 506, and the article name column 509 on the design change contents node registration screen 500, respectively. Therefore, the explanation made in the above will be quoted herein, about those.

In such the linkage registration screen 700 for use of the related function part, in the similar manner of the linkage registration screen 600 for use of the cost, it is possible to use the nodes relating to the contents of design change, as they are, which are registered previously on the design change contents node registration screen 500. In set-up of the linkage relating to the related function part in that case, inputs are made into the related function part change portion column 707, the related function part change kind column 708, and the related function part process column 709, on the linkage registration screen 700 for use of the related function parts. In the example shown in the figure, a “compressor” is inputted into the related function part change portion column 707, the “size change” into the related function part change kind column 708, and the “design, heat-leakage quantity analysis” into the related function part process column 709. When pushing down the OK button 710 under this condition, the data setting up the linkage between the design change contents and the related function part is registered/reserved into the role table storage portion 105, in the form of a related function part rule table.

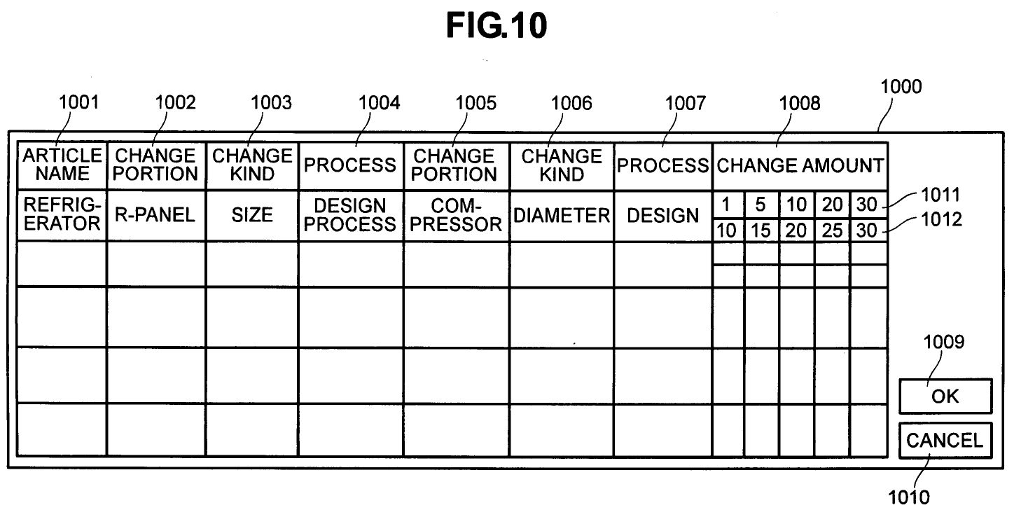

FIG. 10 shows an example of the related function part rule table. In this related function part rule table 100, there are provided the followings: an article name column 1001, a change portion column 1002, a change kind column 1003, a process column 1004, a change portion column 1005 of the related function part, a change kind column 1006 of the related function part, a process column 1007 of the related function part, a change amount column 1008 of the related function part, an OK button 1009, and a cancel button 1010. Each of the article name column 1001, the change portion column 1002, the change kind column 1003, the process column 1004, the change portion column 1005 of the related function part, the change kind column 1006 of the related function part, and the process column 1007 of the related function part, corresponds to the each column on the design change contents node registration screen 500 and/or the linkage registration screen 700 for use of the related function parts, and the nodes which are inputted on the design change contents node registration screen 500 and/or the linkage registration screen 700 for use of the related function parts are registered in each column of those, respectively. The change amount column 1008 of the related function part is a column where registration is made on a quantity of change, in particular, when accompanying the quantitative change or the numerical value change in the contents of the design change on the related function part. In the example shown in the figure, it is divided into an upper stage 1011 and a lower stage 1012, and the change quantity is registered into the upper stage 1011 while the cost corresponding to the change quantity into the lower stage 1012. Further, it is also same to the case of the cost-rule table 900, that the related function part rule table 1000 can be used in the registration of the cases, and with the present embodiment, it is also possible to register the cases, by using the related function part rule table 1000.

A linkage registration screen 800 shown in FIG. 8 is for use of set-up of a linkage, with respect to the design change contents on the performance (i.e., the performance change), being one of the influential factors. This linkage registration screen 800 for use of the performances comprises: a change portion column 801, a memo column 804, a change kind column 805, a process column 806, a changed performance kind column 807, an OK button 808, a cancel button 809, and an article name column 810.

The changed performance kind column 807 is a column where an input is made on the kind of the performance change accompanying with the design change in a form of the node, and an input can be made by using the performance nodes, which are prepared in the performance region 429 on the basic system screen shown in FIG. 4. The structure of each one of the columns other than this corresponds to the change portion column 501, the memo column 504, the change kind column 505, the process column 506, and the article name column 509 on the design change contents node registration screen 500, respectively. Therefore, the explanation made in the above will be quoted herein, about those.

In such the linkage registration screen 800 for use of the performances, in the similar manner to the linkage registration screen 600 for use of the costs, it is possible to use the nodes relating to the contents of design change, as they are, which are registered previously on the design change contents node registration screen 500. In set-up of the linkage relating to the performance changes in that case, an input is made into the change performance kind column 807 on the linkage registration screen 800 for use of the performance. In the example shown in the figure, the “heat leakage amount” is inputted into the changed performance kind column 807. When pushing down the OK button 808 under this condition, the data setting up the linkage between the design change contents and the performance change is registered/reserved into the rule table storage portion 105, in the form a performance change rule table.

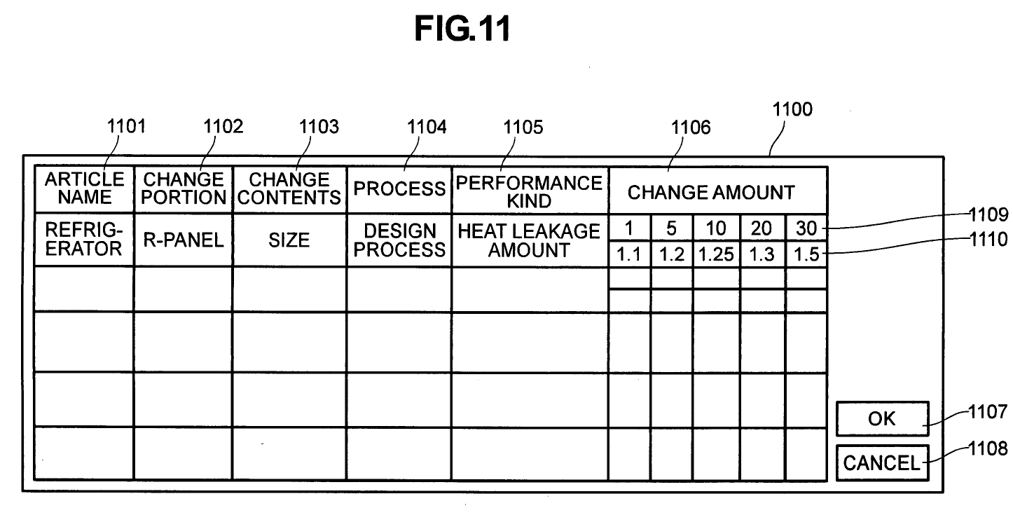

FIG. 11 shows an example of the performance change rule table. In this performance change rule table 1100, there are provided an article name column 1101, a change portion column 1102, a change kind column 1103, a process column 1104, a performance kind column 1105, a performance change amount column 1106, an OK button 1107, and a cancel button 1108. Each of the article name column 1101, the change portion column 1102, the change kind column 1103, the process column 1104 and the performance kind column 1105 corresponds to the each of the columns displayed on the design change contents node registration screen 500 and/or the linkage registration screen 800 for use of the performances, and the nodes inputted on the design change contents node registration screen 500 and/or the linkage registration screen 800 for use of the performances are registered in each of those columns. The performance change amount column 1106 is a column where a quantity of change is registered therein. In the example of the figure, it is divided into an upper stage 1109 and a lower stage 1110, and the change quantity in the design change is registered into the upper stage 1109 while the change amount of performances corresponding to that change quantity into the lower stage 1110. Further, it is possible to use the performance change rule table 1100 for registration of the cases, as is same to the case of the cost rule table 900, and in the present embodiment, it is also possible to make the registration of the cases, by using the performance change rule table 1100.

The registration process of the cases is such as were mentioned above. Next, explanation will be given on the processes when evaluating the influential factors with respect to the design change that is to be made newly. In the present embodiment, the cost, the performance change, and the design change of the related function part are treated as the influential factors of the target of evaluation. Hereinafter, the evaluation process on each of the influential factors will be explained, one by one.

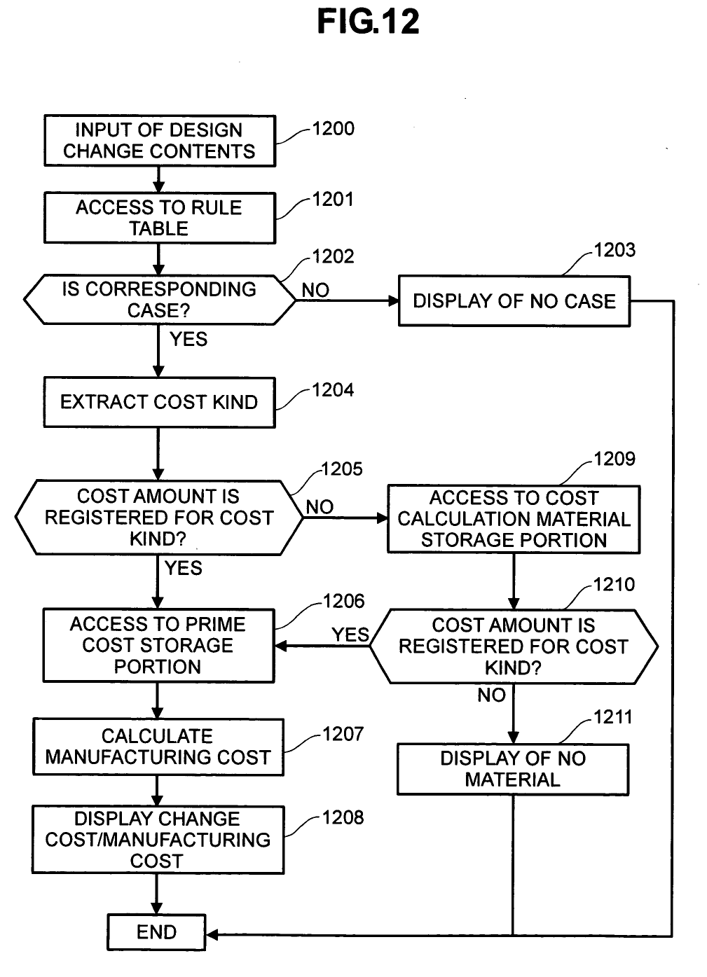

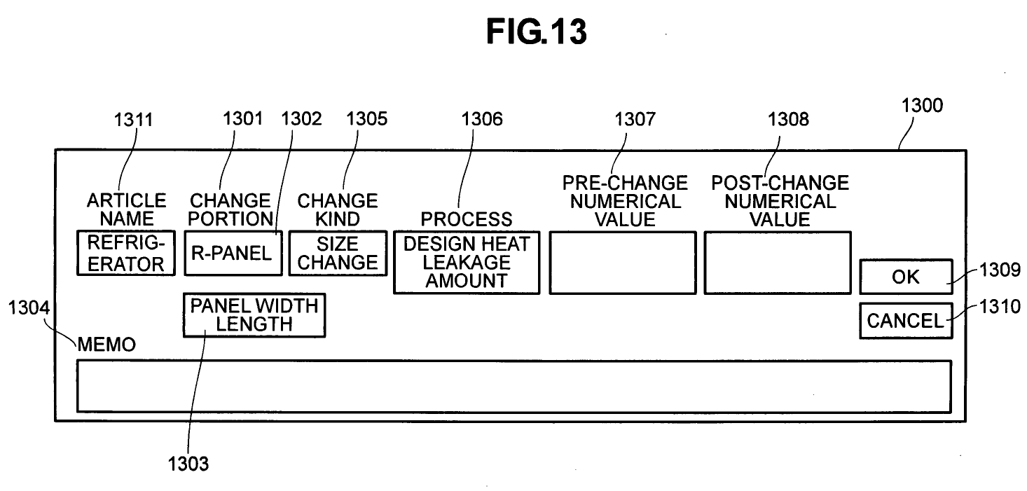

FIG. 12 shows a flow of processes in the cost evaluation on the design change. In a step 1200, the user inputs the design change to be made on the evaluation target. For this, first he/she calls up the change contents inputting screen by pushing down the evaluation deliver/display button on the basic system screen shown in FIG. 4. In this instance, he/she also makes a click on the cost region 414 for the purpose of designating a fact that it is the cost evaluation. FIG. 13 shows therein an example of the change contents inputting screen. This change contents inputting screen 1300 comprises: a change portion column 1301, a memo column 1304, a change kind column 1305, a process column 1306, a pre-change numerical value column 1307, a post-change numerical value column 1308, an OK button 1309, a cancel button 1310, and an article name 1311. The pre-change numerical value column 1307 and the post-change numerical value column 1308 are ones where the pre-change numerical value and the post-change numerical value are inputted, respectively, in a case where the design change content accompanies a quantitative change or a numerical value change. The each structure of the columns other than this corresponds to that of the change portion column 501, the memo column 504, the change kind column 505, the process column 506, and the article name column 509 on the design change contents node registration screen 500, respectively. Therefore, the explanation made in the above will be quoted herein, about those.

In the example shown in the figure, the “refrigerator” is inputted into the article name 1311, the “R-panel” and the “panel width length” in the change portion columns 1302 and 1303 of the change portion column 1301, respectively, the “size change” in the change kind column 1305, and “design, heat leakage amount analysis” in the process column 1306, respectively. When pushing down the OK button 1309 under the condition of inputting the data in each of the columns, in this manner, the design change contents of the evaluation target are inputted into the present system.

The present system, receiving the input of the design change contents on an evaluation target, makes an access to the cost rule table which is stored in the rule table storage portion 105 shown in FIG. 1 (step 1201), thereby searching out a case corresponding to the design change contents inputted (i.e., a case being same or similar to the inputted design change contents) (step 1202). In a case where no case can be found corresponding thereto, a fact of that is displayed (step 1203), and then the process is ended. If there can be found a case corresponding thereto, the kind of cost (i.e., the prime cost factor) is extracted therefrom, which is changed accompanying with the design change contents in that case (step 1204). Next, it is decided on whether a cost amount is registered or not, with respect to the extracted kind of the cost (step 1205). If the cost amount is registered, an access is made to the prime cost table stored in the prime cost table storage portion 106 (step 1206), thereby calculating out a manufacturing prime cost upon the basis of that prime cost table (step 1207). When a result can be obtained, it is displayed (step 1208), and the process is ended. On the other hand, if decided that no cost amount is registered in the step 1205, an access is made to the cost calculation material storage portion 107 (step 1209), thereby searching the cost amount relating to the extracted cost kinds on the cost calculation materials stored therein (step 1210). If there is, the processes are carried out on the steps 1206 and thereafter, on the other hand if there is not, a fact of that is displayed (step 1211), and then the process is ended.

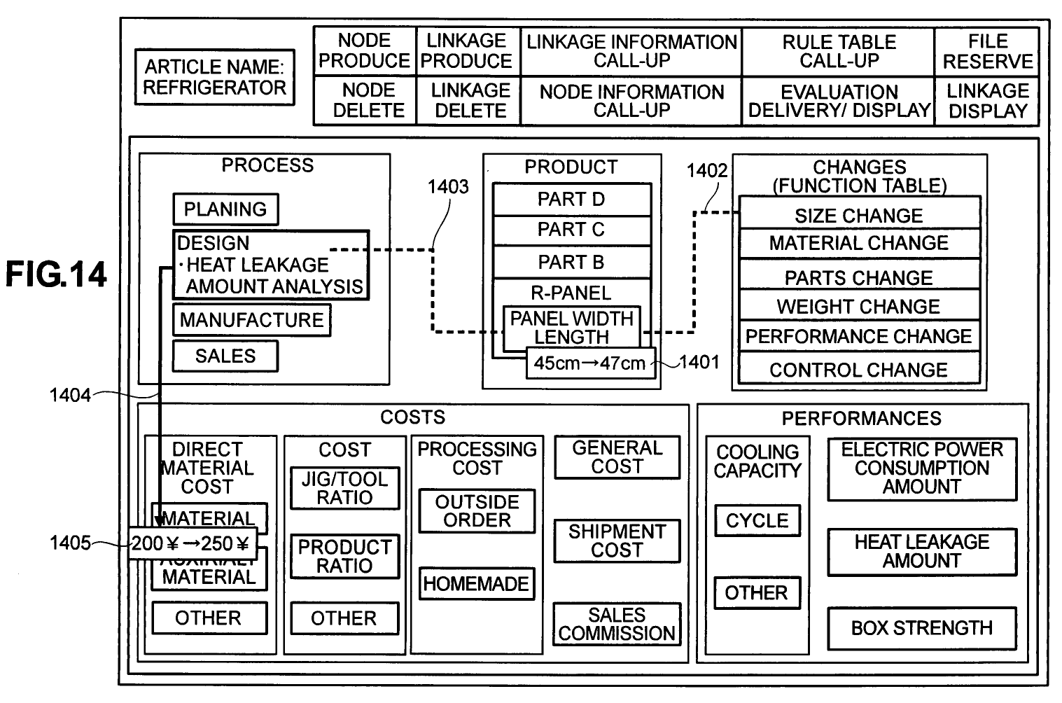

It is common that the display of the result obtained in the step 1208 is made in a form of a design change influence network. FIG. 14 shows an example of that display screen. In the example shown in the figure, since the target portion of design change is the “panel width length” of the “R-panel”, upon the basis of the example of the input mentioned above, the node “panel width length” is displayed with emphasis within the node region of the “R-panel”, and a change amount value display 1401 is made in that portion. And, it is displayed that the change kind is the “size change” by connecting the node “size change” in the change region with an aid of a chain line 1402, and that the related process is the “design, heat leakage amount analysis” by connecting the node “design, heat leakage amount analysis” in the process region with an aid of a chain line 1403. Also, the relationships of the influential factors with respect to such the design change contents (herein, the cost items because of the cost evaluation) are displayed on the linkage display, by means of a solid line attached with an arrow. In the example shown in the figure, the related cost node is “material”, and a cost change value display 1405 is made therein.

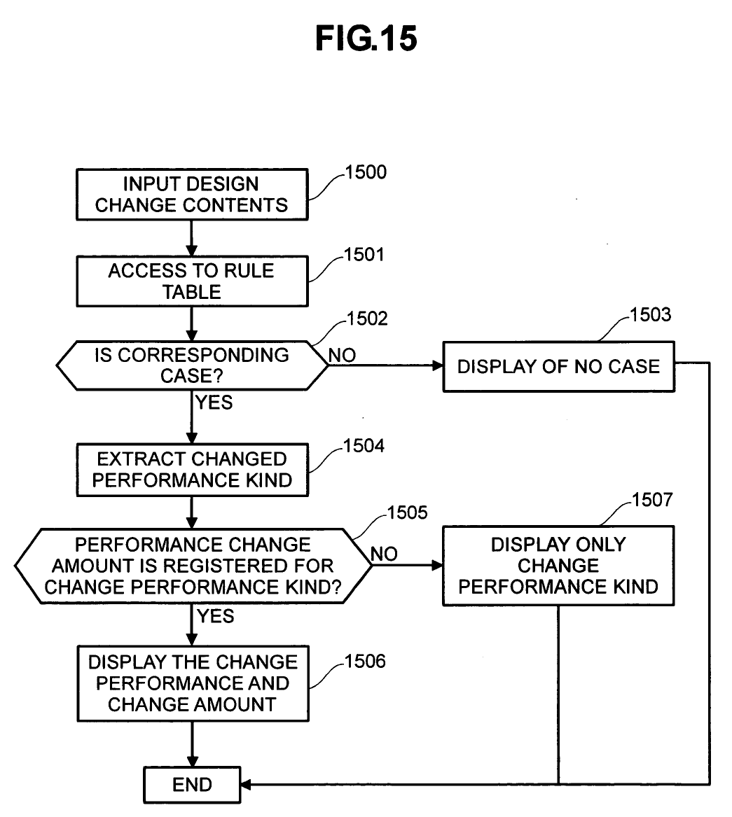

FIG. 15 shows a flow of processes in the performance change evaluation on the design change. In a step 1500, the evaluation deliver/display button is inputted on the basic system screen, in the similar manner as to the cost evaluation, thereby calling up the change contents inputting screen shown in FIG. 13, and the contents of design change are inputted. However, in this case, a click is made on the performance region 429 on the basic system screen for designating a fact that it is the performance evaluation. The present system, receiving the input of the evaluation target design change contents, makes an access to the performance change rule table stored in the rule table storage portion 105, which is shown in FIG. 1 (step 1501), thereby searching a case corresponding to the design change contents inputted (step 1502). If there cannot be found any case corresponding thereto, a fact of that is displayed (step 1503), and then the process is ended. On the other hand, if there can be found a case corresponding thereto, the kind of performance is extracted, which is changed accompanying with the design change contents in that case (step 1504). Next, it is decided on whether the change quantity is registered or not, relating to the performance change extracted (step 1505). In a case when deciding that there is registered the performance change amount, the kind and the change amount is displayed about the performance change (step 1506), and then the step is ended. On the other hand, in the case of deciding that there is no registration made on the performance change amount in the step 1505, only the kind of the performance change is displayed (step 1507), and then the process is ended.

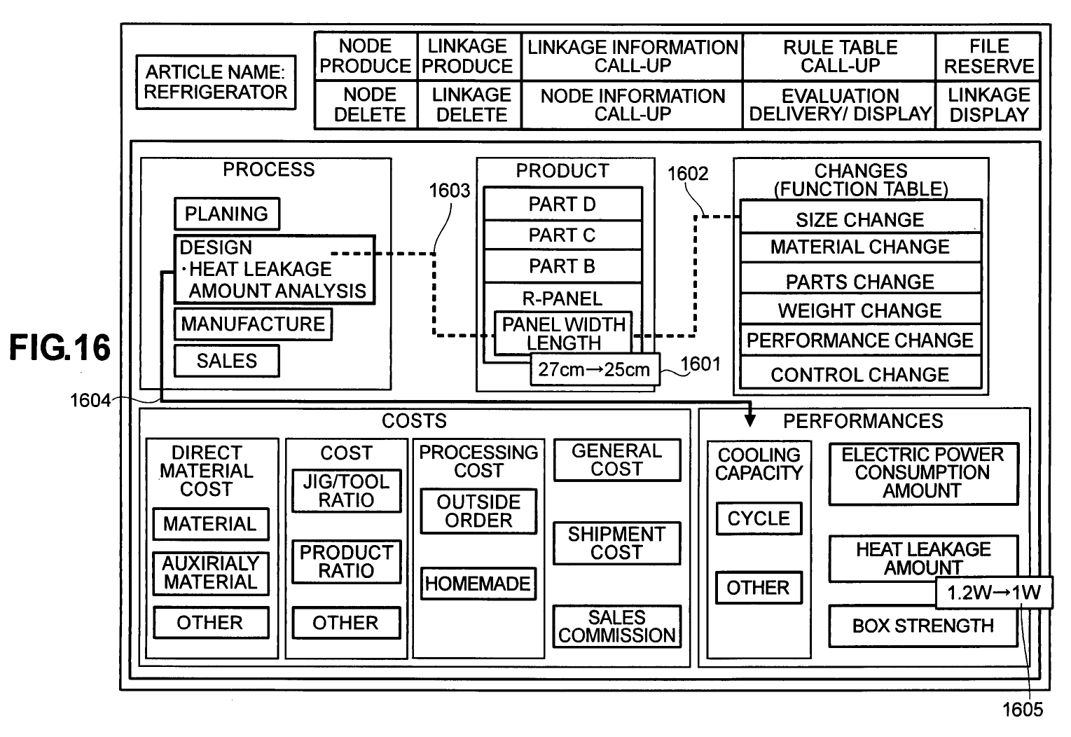

It is common that the display of the results in the steps 1506 and 1507 is made in a form of the design change influence network, in the similar manner to the case of the cost evaluation. FIG. 16 shows an example of that display screen. In this example, as is similar to the example shown in FIG. 14, since the target portion of design change is the “panel width length” of the “R-panel”, then the node “panel width length” is displayed with emphasis, and a change amount value display 1601 is made in that portion. Also, with respect to this node “panel width length”, it is displayed that the change kind is the “size change” by connecting the node “size change” in the change region with an aid of a chain line 1602, and that the related process is the “design, heat leakage amount analysis” by connecting the node “design, heat leakage amount analysis” in the process region with an aid of a chain line 1603. And also, the relationship of the performance change with respect to such the design change contents is displayed by means of a solid line attached with an arrow, and in a case where the performance change is caused, there is also made a performance change amount display 1605 of that.

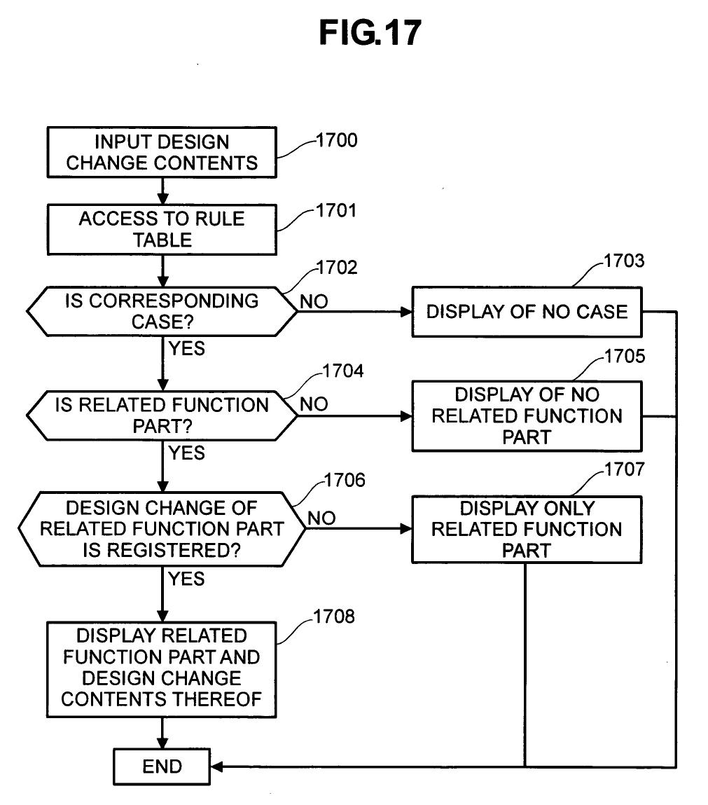

FIG. 17 shows a flow of processes in the related function part evaluation on the design change. In a step 1700, the evaluation deliver/display button on the basic system screen is pushed down, in the similar manner to the case of the cost evaluation and the performance change evaluation, thereby calling up the change contents inputting screen shown in FIG. 13, and the contents of design change are inputted. However, in this case, a click is made on the related function part region (i.e., the product region 405, since the product region 405 is used in common with the related function part region, as was explained in the above) on the basic system screen, for designating a fact that it is the related function part evaluation. The present system, receiving the input of the evaluation target design change contents, makes an access to the related function part rule table stored in the rule table storage portion 105, which is shown in FIG. 1 (step 1701), thereby searching a case corresponding to the design change contents inputted (step 1702). If there cannot be found any case corresponding thereto, a fact of that is displayed (1703), and then the process is ended. If there can be found a case corresponding thereto, it is decided on that case, whether there is a related function part or not, on which the design change is needed accompanying with the design change contents in that case (step 1704). If deciding there is no related function part, a fact of that is displayed (step 1705), and then the process is ended. On the other hand, if there is the related function part, further a decision is made on whether the design change contents are registered or not, about that related function part (step 1706). In a case if there is no design change contents registered, the display is made only on the related function part (step 1707), and then the process is ended. On the other hand, if there are the design change contents registered, the display is made on the related function part and the design change contents (step 1708), and then the process is ended. It is common that the display of those is made in the form of the design change influence network, in the similar manner to the case of the cost evaluation or the performance change evaluation mentioned above.

The above is the case of making an evaluation on the influential factors with respect to the design change. Next, explanation will be given on processes, in particular, in a case of making study/evaluation upon the design change when achieving the target cost in the cost reduction, and a case of making the study/evaluation upon the design change when achieving the target performances in the improvement of performances.

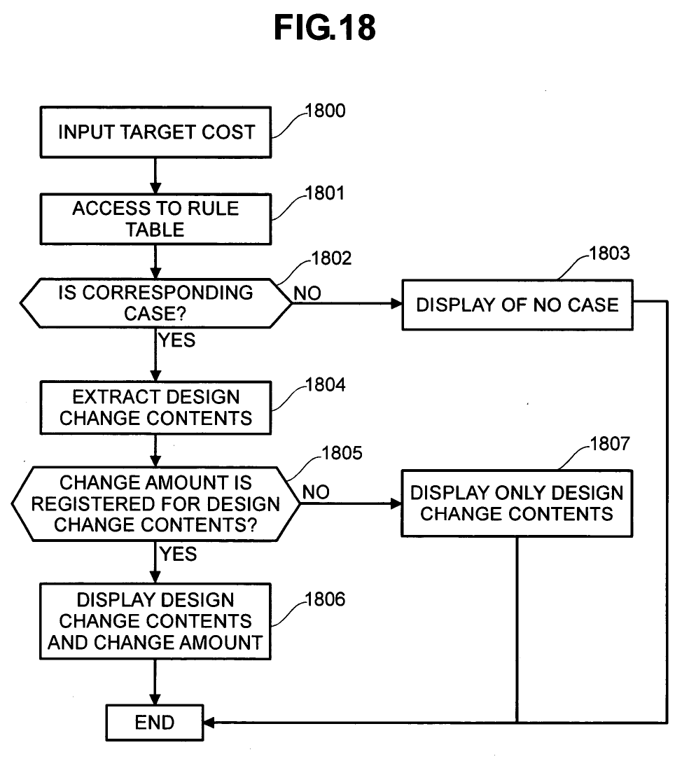

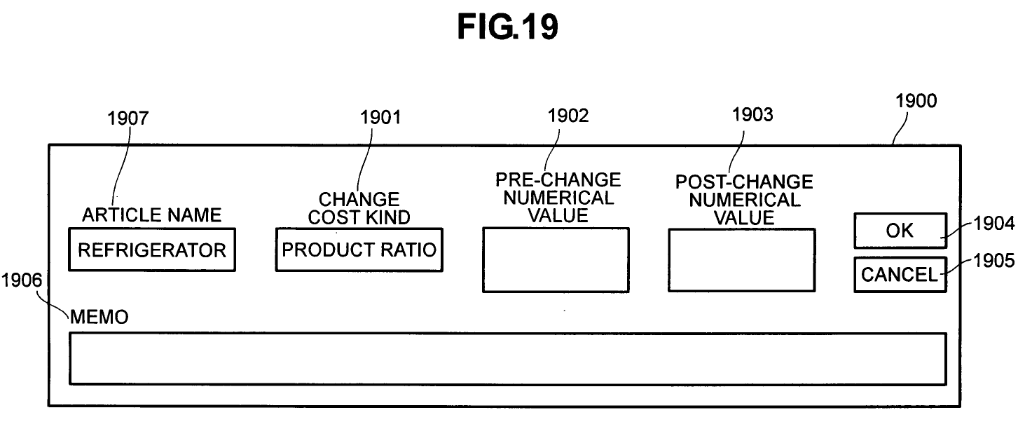

FIG. 18 shows a flow of processes in the study/evaluation made on upon the design change, for the purpose of achieving the target cost. In a step 1800, a target cost is inputted. For that, first a target cost inputting screen is called up, by making a click on the cost region 414 on the basic system, which is shown in FIG. 4 mentioned above. FIG. 19 shows an example of the target cost inputting screen. This target cost inputting screen 1900 comprises: a change cost kind column 1901, a pre-change numerical value column (the present cost) 1902, a post-change numerical value (the target cost) column 1903, an OK button 1904, a cancel button 1905, a memo column 1906, and an article name column 1907. The change cost kind column 1901 is a column where a cost item (e.g., the prime cost) is inputted to be a target of the cost reduction, and in the example shown in the figure, there is inputted “product ratio”. The pre-change numerical value column 1902 is a column where the present cost is inputted therein, and the post-change numerical value column 1903 is a column where the target cost is inputted therein. The figure shows an example, in the condition thereof, that any numerical value is not yet inputted in those. The article name column 1907 is a column where the article name of the target product is inputted therein, and the “refrigerator” is inputted by the example shown in the figure. When pushing down the OK button 1904 after inputting those necessary data, the contents relating to the target cost are inputted into the present system, as the target for the study/evaluation on the design change.

The present system, receiving the inputs of the target cost contents, makes an access to the cost rule table, which is stored in the rule table storage portion 105 shown in FIG. 1 (step 1801), thereby searching a case corresponding to the target cost contents inputted (i.e., the case accompanying the cost change, being same or similar to the inputted target cost change) (step 1802). If there can be found no corresponding case, a fact of that is displayed (step 1803), and then the process is ended. If there is any case corresponding thereto, the contents of the design change is extracted from in that case (step 1804). Next, it is decided on whether the change amount (i.e., the change amount of the size, etc.) is registered or not in the design change contents extracted (step 1805). In a case if the change amount is registered, the design change contents and the change amount are displayed (step 1806), and the process is ended. On the other hand, if it is decided that no registration is made of the change amount in the step 1805, only the design change contents are displayed (step 1807), and then the process is ended.

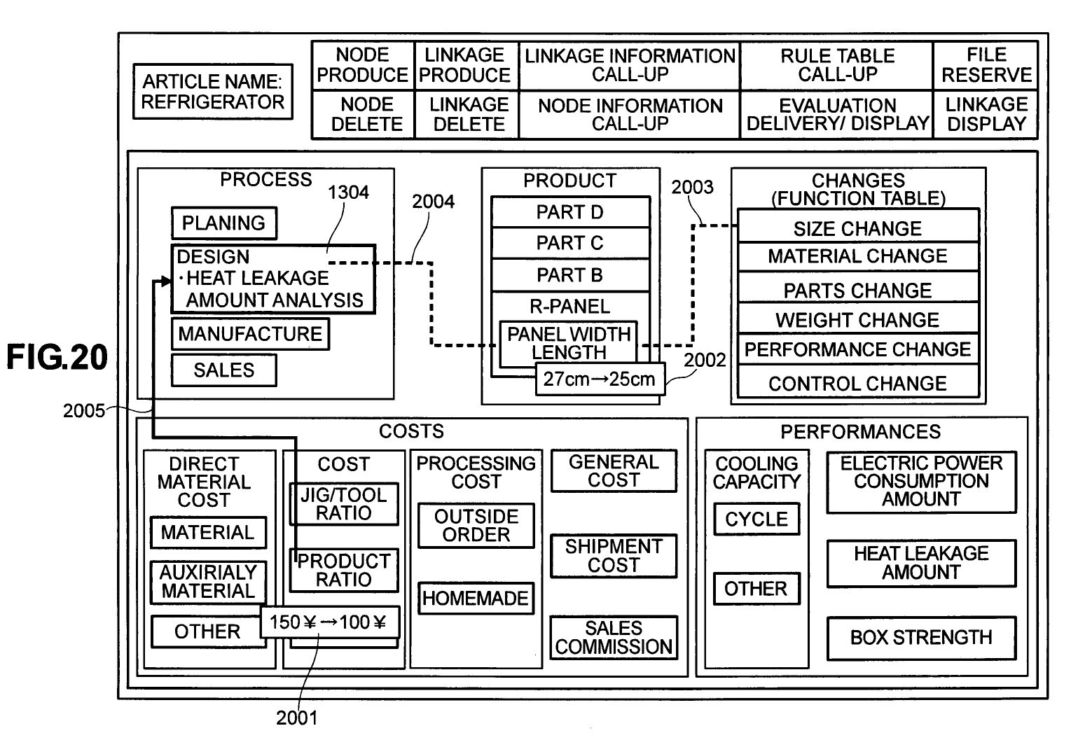

It is common that the display of the results in the steps 1806 and 1807 is made in the form of the design change influence network. FIG. 20 shows an example of that. In the example shown in the figure, the prime cost factor relating to the target cost is the “product ratio”, and about this, it is the case of reducing the cost from the present condition, i.e., ¥150, down to ¥100, and then that target cost display 2001 is displayed. Further, as the contents of the design change, being appropriate for achieving that target cost, the node “panel width length” is displayed with emphasis thereon in the node region “R-panel”, and the change amount value display 2002 is made in that portion; i.e., meaning that an example thereof is the change of the width length, from 27 cm to 25 cm, on the R-panel. Also, it is displayed that the change kind is the “size change” by connecting the node “size change” in the change region to the node “panel width length” with an aid of a chain line 2003, and that the related process is the “design, heat leakage amount analysis” by connecting the node “design, heat leakage quantity analysis” in the process region with an aid of a chain line 2004. Also, display is made on the relationship between such the design change contents and the target cost, by means of a linkage display 2005 of a solid line attached with an arrow.

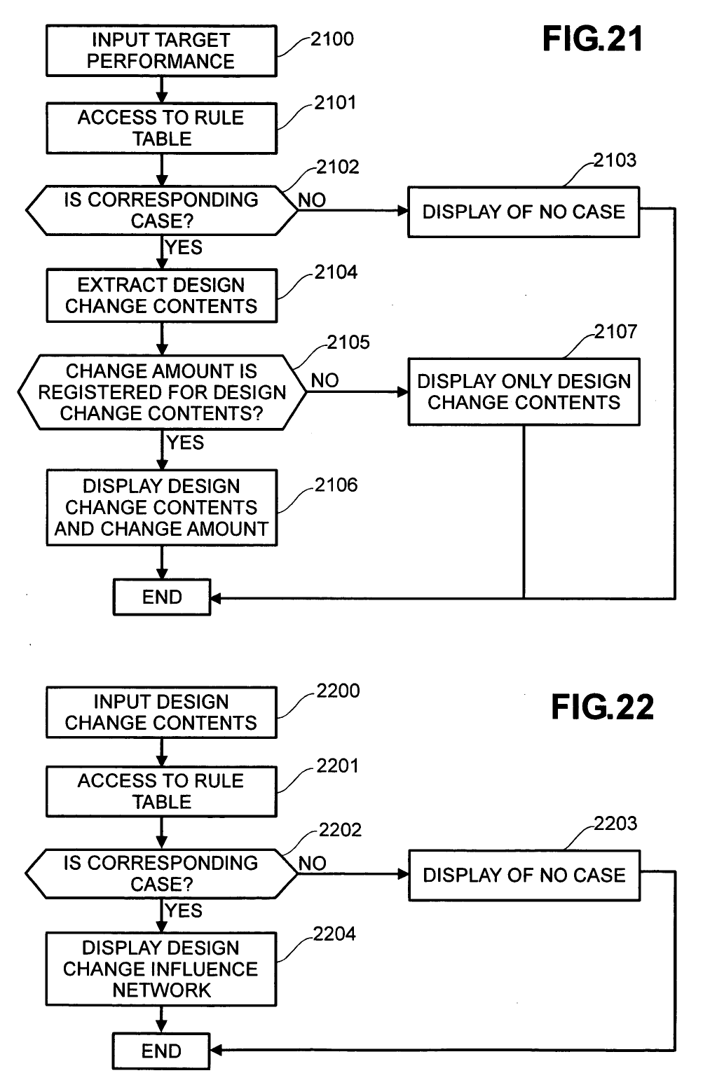

FIG. 21 shows a flow of processes in the study/evaluation on the design change, for the purpose of achieving the target performances. In a step 2100, an input is made for the target performances. The input operation thereof is basically same to that of the input of the target cost. However, in this case, a target performance inputting screen is called up, by making a click on the performance region 429 on the basic system screen, which is shown in FIG. 4. The target performance inputting screen is basically same to the target cost inputting screen shown in FIG. 19, therefore the explanation will be omitted herein, about that.

The present system, receiving the inputs of the target performance contents through the operation on the target performance inputting screen, makes an access to the performance change rule table, which is stored in the rule table storage portion 105 shown in FIG. 1 (step 2101), thereby searching a case corresponding to the target performance contents inputted (step 2102). If there cannot be found any case corresponding thereto, display is made on the fact of that (step 2103), and then the process is ended. If there can be found any case corresponding thereto, then the contents of the design change is extracted in that case (step 2104). Next, determination is made on whether the change amount (such as, the change amount of size, etc.) is registered or not in the design change contents extracted (step 2105). In a case if the change amount is registered, then the design change contents and the change amount are displayed (step 2106), and the process is ended. On the other hand, if it is determined that no registration is made of the change amount in the step 2105, only the design change contents are displayed (step 2107), and then the process is ended.

It is also common that the display of the results obtained in the steps 2106 and 2107 is made in the form of the design change influence network, and for example, in a case where the target performance has a content to reduce the heat leakage amount from 1.2W down to 1W, in the refrigerator, for example, the display screen is as such the example, which is shown in FIG. 16 mentioned above.

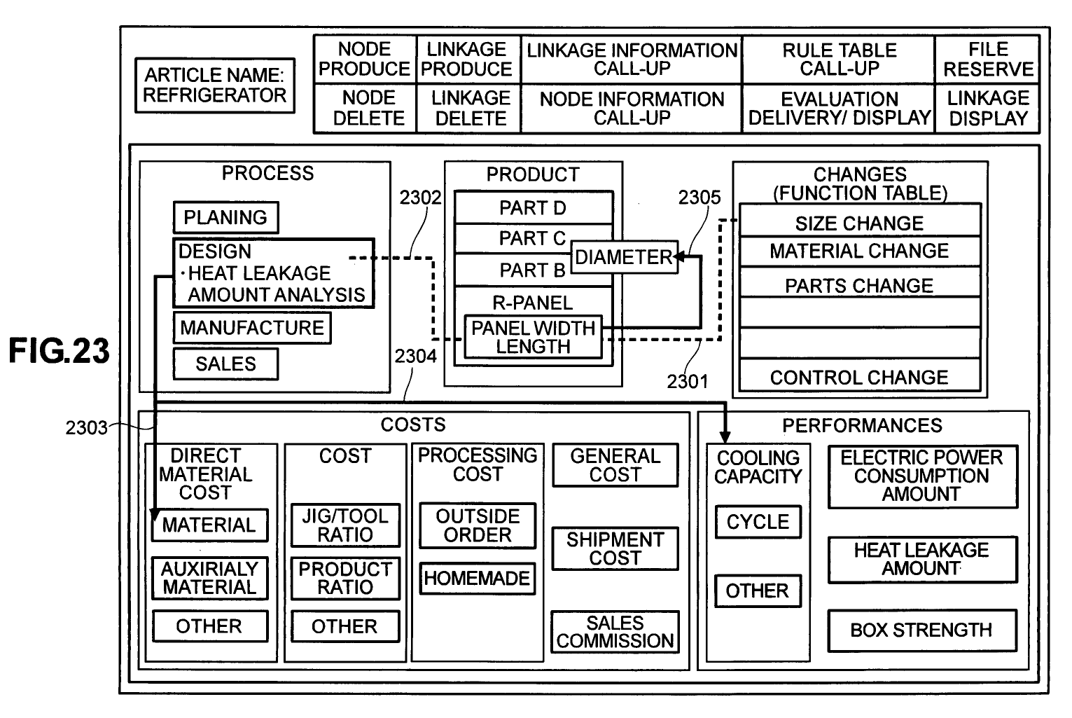

According to the present invention, other than those processes mentioned above, in a case of trying to make the design change, newly, it is so structured that also the process of displaying the design change influence network can be conducted for making a confirmation only on the relationships between the influential factors in that design change. FIG. 22 shows a flow of processes in the design change influence network display. In a step 2200, an input is made on the design change contents. For that, the change contents inputting screen shown in FIG. 13 is called up by pushing down the linkage display button on the basic system screen shown in FIG. 4, and then the input is made on the design change contents with using this screen.

The present system, receiving the input of the design change contents, makes an access to various kinds of rule tables, which are stored in the rule table storage portion 105 shown in FIG. 1 (step 2201), thereby searching a case corresponding to the inputted design change contents (step 2202). If there cannot be found any case corresponding thereto, a display is made on that fact (step 2203), and then the process is ended. If there can be found any case corresponding thereto, a display is made of the design change influence network about the contents of the design change in that case (step 2204), and then the process is ended.

FIG. 23 shows an example of that display screen. In the figure, there is shown a display screen of a case where an input is made on the contents that the R-panel of the refrigerator is changed on the panel width length thereof, as the contents of the design change. Namely, since the target portion of design change is the “panel width length” of the “R-panel”, then the node “panel width length” is displayed with emphasis in the node region of the “R-panel”, and the node “size change” in the change region is connected to with an aid a chain line 2301, thereby displaying that the change kind is the “size change” and the node “design, heat leakage amount analysis” in the process region with an aid of a chain line 2302, thereby indicating that the related process is the “design, heat leakage amount analysis”. Also, a display is made on the relationships between the influential factors (i.e., the cost, the performance change, and the related function part) with respect to such the design change, by means of a linkage display of a solid line attached with an arrow. In more details, the relationship of the cost is displayed by means of a linkage display 2303, the relationship of the performance change is by means of a linkage display 2304, and the relationship of the related function parts is by means of a linkage display 2305.

The embodiments explained above are the preferable one(s), for reducing the present invention to the practices thereof, however, the present invention should not be restricted only thereto. The present invention may be practiced in a form of an appropriate embodiment, within a region, but not departing from the basic structure of: accumulating the cases relating to the design changes, making an evaluation on the influential factors in the design change upon the basis of the accumulated cases, or visualizing and displaying the relationships of the influential factors to the design changes.

With the design change assistance system according to the present invention, a database is produced about the existing cases of design changes, and upon the bas is of that database, an evaluation can be made on the influential factor in the design change. With such the design change assistance system, according to the present invention, since it is made upon the basis of the existing design change cases, the design change can be made, but preventing situations where a confirmation is forgotten or neglected to be made on the influential factors when making the design change, or an error is caused when calculating out the costs and the performances thereof, thereby enabling the design change with much higher efficiency.

Also, with the design change assistance system, according to the present invention, the database is produced about the existing cases of design change, and the relationships of the influential factors with respect to the design change contents can be displayed upon the basis of this database, by means of the combination of the node display and the linkage display. With such the design change assistance system, according to the present invention, the relationships of the influential factors with respect to the design change contents can be grasped with ease, through a visualized display by means of the design change influence network, the design change can be made, but preventing situations where a confirmation is forgotten or neglected to be made on the influential factors when making the design change, or an error is caused when calculating out the costs and the performances thereof, thereby enabling the design change with much higher efficiency.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. A design change assistance system for assisting an evaluation on a related influential factor in a design change, when conducting the design change, comprising:
a case input means for inputting a design change case, including existing design change contents and an item of an influential factor relating to the design change contents;
a database for accumulating data inputted through said case input means;
an evaluation target design change input means for inputting contents of the design change on an evaluation target; and
a design change evaluation delivery means for delivering an evaluation on the influential factor about the design change on said evaluation target inputted in said evaluation target design change input means, upon basis of the case data accumulated in said database.

2. The design change assistance system, as described in the claim 1, wherein said influential factor includes at least one or more of: a cost item accompanying with the design change on said evaluation target, a performance change of a design change target product accompanying with the design change on said evaluation target, and a presence of a related function part, on which a related design change is necessary accompanying with the design change on said evaluation target.

3. The design change assistance system, as described in the claim 2, wherein such design change contents can be delivered from upon basis of said case data, that a target cost and/or a target performance, which is set up for an object of the design change, can be achieved.

4. The design change assistance system, as described in the claim 1, wherein such design change contents can be delivered from upon basis of said case data, that a target cost and/or a target performance, which is set up for an object of the design change, can be achieved.

5. A design change assistance system for assisting an evaluation on a related influential factor in a design change, when conducting the design change, comprising:
a case input means for inputting a design change case, including existing design change contents and an item of an influential factor relating to the design change contents;
a database for accumulating data inputted through said case input means; and
an evaluation target design change input means for inputting contents of the design change on an evaluation target, wherein:
a relationship of said influential factor with respect to said evaluation target design change inputted in said evaluation target design change input means can be displayed in a form of a design change influence network, by means of a combination of a node display and a linkage display, upon basis of the case data accumulated in said database.
